(19) United States
(12) Patent Application Publication
(10) Pub. No.: US 2008/0072967 A1
(43) Pub. Date: Mar. 27, 2008

(54) Self-sealing floor drain

(76) Inventor: Hsieh Hsien Wen, Hsin Chu Hsien (TW)

Correspondence Address: BRUCE H. TROXELL, SUITE 1404, 5205 LEESBURG PIKE, FALLS CHURCH, VA, 22041, US

(21) Appl. No.: 11/526,080

(22) Filed: Sep. 25, 2006

(51) Int. Cl. F16L 5/00

(52) U.S. Cl. 137/362

(57) ABSTRACT

A self-sealing floor drain includes a hollow cylindrical drain basket mounted in a drain pipe or an existing bell-type floor drain, and a sealing disc movably mounted at a water outlet of the drain basket. The drain basket has a case, on an inner wall surface of which a switch unit is mounted. A torsion spring is provided in the switch unit for opening and closing the sealing disc. Waste water flown into the drain basket applies a downward force on the sealing disc to thereby open a bottom sealing joint of the drain basket to drain the waste water. When the waste water has been drained, the torsion spring brings the sealing disc upward to seal the sealing joint again, so that sewage, bad smell, hazardous gas, and insects are stopped from entering into a room via the floor drain due to a positive pressure state in the drain pipe.

### FIELD OF THE INVENTION

The present invention relates to an interface for connecting an indoor floor to a draining system, and more particularly to a self-sealing floor drain for draining waste water smoothly and preventing sewage in a drain pipe from flowing back into indoor floor.

### BACKGROUND OF THE INVENTION

It is known that a floor drain is an important interface for connecting an indoor floor to a draining system. One of the conventional floor drains is a so-called bell-type floor drain, which generally includes an inverted bell-shaped drain basket and a strainer. The drain basket of the conventional bell-type floor drain is easily removable from the floor, and might by moved upward by a positive pressure in a drain pipe system to destroy a water sealing effect of the floor drain, resulting in the invasion of bad smell, hazardous gas, insects, and sewage from the drain pipe into a room via the floor drain. To prevent the bad smell, hazardous gas, insects, and sewage from entering into a room, self-sealing floor drains have been developed and received wide acceptance. FIG. 1 shows a device preventing sewage from flowing backward disclosed in Chinese Patent No. 99801762.0. As shown, the device is a switch unit employing reverse water energy to achieve upward and downward movements thereof. This switch unit includes a unique piston-like structure to effectively solve the self-sealing problem in the conventional floor drains. However, this switch unit also includes a weight, which offsets the opening size of the switch unit under water pressure. Moreover, since the switch unit is located at a center of the floor drain, it blocks a path via which waste water is drained when the switch unit is moved upward, and inevitably lowers the draining speed. When the amount of waste water is large, part of the waste water fails to pass through the floor drain into the drain pipe and overflows the floor drain. Further, the switch unit is driven to move upward and downward via meshed gears and rack, and therefore involves in complicate structure and high manufacturing cost. Moreover, the weight and the switch unit of the floor drain are mounted on a centered slide rod in the drain basket. Large amount of waste water flows along the centered slide rod and permeates into the weight and the switch unit, resulting in a switch unit working in an environment containing waste water and thereby failing to work normally. That is, the device disclosed in Chinese Patent No. 99801762.0 limits the function of a floor drain and makes the floor drain unstable in performance.

### SUMMARY OF THE INVENTION

A primary object of the present invention is to provide a self-sealing floor drain to eliminate the drawbacks of unsmooth draining, complicate structure, high manufacturing cost, and unstable function existed in the conventional floor drains.

To achieve the above and other objects, the self-sealing floor drain according to the present invention includes a hollow cylindrical drain basket mounted in a drain pipe or an existing bell-type floor drain, and a sealing disc movably mounted at a water outlet of the drain basket. The drain basket has a case, on an inner wall surface of which a switch unit is mounted. And, a torsion spring is provided in the switch unit for opening and closing the sealing disc.

The self-sealing floor drain of the present invention has reasonable and simple structure to enable lowered manufacturing cost, as well as convenient, stable, and safe use thereof to allow smooth draining of waste water.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a vertical sectional view of a conventional floor drain;

FIG. 2 is a vertical sectional view showing the structure of a self-sealing floor drain according to a preferred embodiment of the present invention;

FIG. 3 is a vertical sectional view of a case of the self-sealing floor drain of FIG. 2;

FIG. 4 is a top view of FIG. 3;

FIG. 5 is a vertical sectional view of a switch unit for the self-sealing floor drain of FIG. 2;

FIG. 6 is top view of FIG. 5;

FIG. 7 is a vertical sectional view of a torsion spring pull rod for the self-sealing floor drain of FIG. 2; and

FIG. 8 is a top view of FIG. 7.

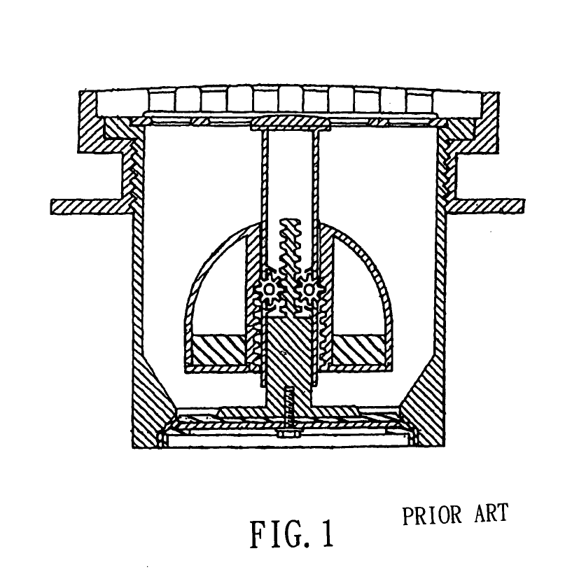

### DETAILED DESCRIPTION OF THE PREFERRED EMBODIMENTS

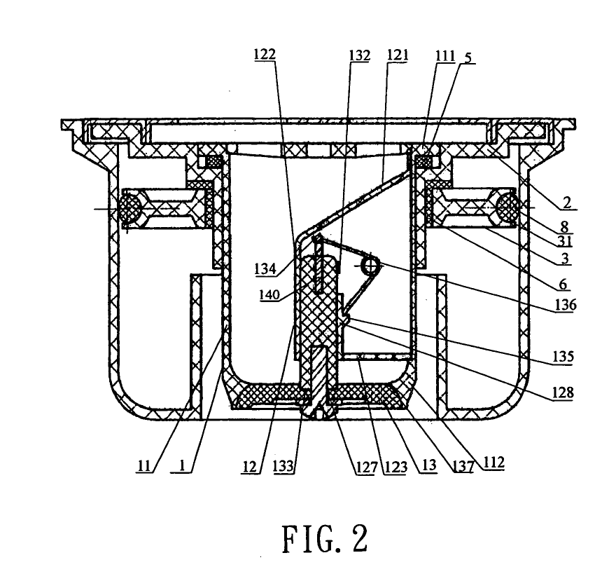

Please refer to FIGS. 2 to 8, in which a self-sealing floor drain according to a preferred embodiment of the present invention is shown. The self-sealing floor drain provided by the present invention may be independently mounted to a drain pipe or be used with an existing bell-type floor drain. In the illustrated embodiment, the self-sealing floor drain is used with an existing bell-type floor drain. As shown in FIG. 2, the self-sealing floor drain according to the present invention includes a drain basket 1, a connecting interface 2, and a sealing member 3. The drain basket 1 may be mounted to a drain pipe or be used with an existing bell-type floor drain. The connecting interface 2 is externally mounted around the drain basket 1 for directly connecting to the drain pipe or to the bell-type floor drain. The sealing member 3 is mounted around an outer side of the connecting interface 2 to provide a sealing effect between the connecting interface 2 and an inner wall surface of the existing bell-type floor drain or the drain pipe.

The drain basket 1 includes a case 11, a switch unit 12, and a sealing disc 13.

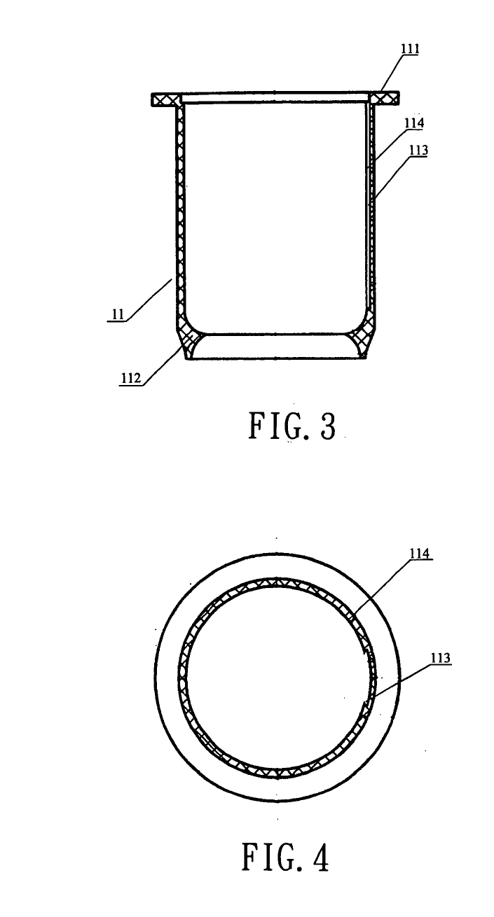

As shown in FIGS. 3 and 4, the case 11 is a hollow cylinder having a radially outward flange 111 integrally formed around a top water inlet thereof. The case 11 is formed at a bottom with a water outlet. A sealed section 112 is downward extended from a position slightly higher than the water outlet to a slightly radially inward projected position. The sealed section 112 has curved upper and lower surfaces. The case 11 is provided on an inner sidewall surface 114 with an axially extended shallow recess with two opposite slide grooves 113. The shallow recess may be formed at any place on the inner sidewall surface 114 of the case 11. The two slide grooves 113 have a triangular cross section. However, the slide grooves 113 may also be any other geometrical cross section.

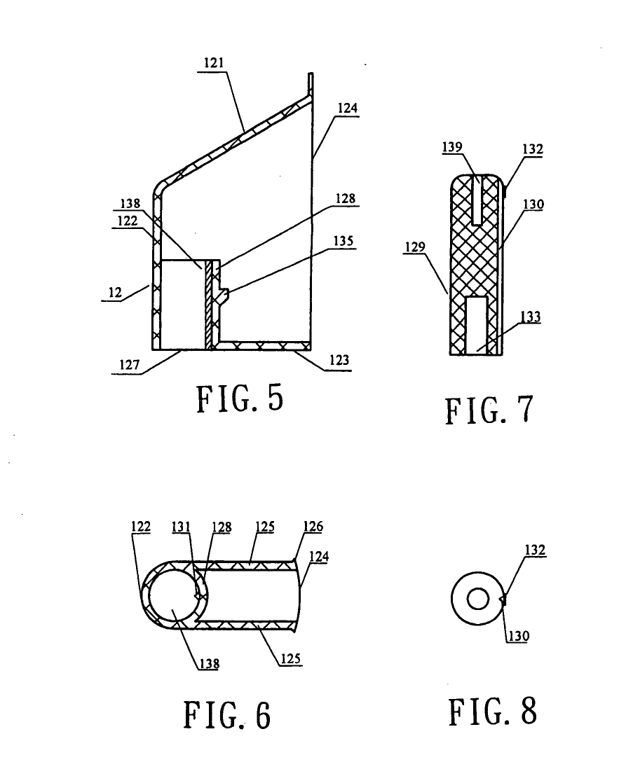

As can be seen from FIGS. 5 and 6, the switch unit 12 is a hollow body having a trapezoid vertical section and a substantially oblong cross section. The switch unit 12 has a top surface 121 and a left end wall surface 122, both of them have a curved cross section to prevent impurities and wastes, such as hair, in waste water from being accumulated or trapped thereat to block water flown into the floor drain. The switch unit 12 also has an open right end 124 and two sidewalls 125. Each of the two sidewalls 125 is integrally provided along an end adjacent to the open right end 124 with an outward protruded edge 126, which has a cross section and size identical to that of the slide groove 113 on the case 11. In the illustrated embodiment, the protruded edges 126 have a triangular cross section. The switch unit 12 is installed in the case 11 by inserting the protruded edges 126 into the slide grooves 113, so that the protruded edges 126 and the slide grooves 113 are engaged with one another in the manner of tight fitting. End surfaces of the sidewalls 125 and the protruded edges 126 of the switch unit 12 in contact with the case 11 also have a curved cross section corresponding to the curved inner sidewall surface 114 of the case 11, so that the switch unit 12 may be tight fitted to the case 11. Therefore, the switch unit 12 may be tightly mounted to the case 11 via engagement of the protruded edges 126 with the slide grooves 113, and axially slidable along the slide grooves 113. The switch unit 12 includes a bottom surface 123, on which a through hole 127 is formed. The bottom surface 123 is integrally formed on an upper side thereof with a vertically extended curved wall 128, which is concentric with the through hole 127 and has an inner diameter the same as a diameter of the through hole 127. The curved wall 128 together with the curved left end wall 122 of the switch unit 12 define an internal hollow guide pipe 138, which is concentric with the through hole 127 and has an inner diameter the same as the diameter of the through hole 127. Alternatively, the hollow guide pipe 138 may be directly integrally formed on the bottom surface 123.

A cylindrical torsion spring pull rod 129 is provided in the hollow guide pipe 138. As can be seen from FIGS. 7 and 8, the torsion spring pull rod 129 is provided on an outer wall surface with an axially extended groove 130 of any geometrical cross section. In the illustrated embodiment, the groove 130 has a triangular cross section. Meanwhile, the hollow guide pipe 138 is provided on an inner wall surface with an axially extended rib 131 having a cross section corresponding to the groove 130. The torsion spring pull rod 129 is mounted in the hollow guide pipe 138 by aligning and engaging the groove 130 with the rib 131, such that the torsion spring pull rod 129 is guided by the rib 131 to slide in the hollow guide pipe 138 only in an axial direction. A stopper 132 is provided near an upper end of the torsion spring pull rod 129 to limit a distance by which the torsion spring pull rod 129 can be moved downward in the hollow guide pipe 138. The torsion spring pull rod 129 is provided at a lower end surface with an internally threaded hole 133, and at an upper end surface with a hole 139 for a bar 140 to insert therein. A spring holding ring 134 is connected to a top of the bar 140. The bar 140 may be integrally formed with or additionally screwed to the torsion spring pull rod 129. The hollow guide pipe 138 is also integrally formed on the outer wall surface with a spring seat 135, on a top center of which a dent is provided. A torsion spring 136 is mounted in the switch unit 12 with two ends separately movably connected to the spring holding ring 134 on the bar 140 and the dent on the spring seat 135.

The sealing disc 13 is located at the bottom of the case 11 below the sealed section 112. The sealing disc 13 has an annular lower end surface flush with the bottom of the case 11, and has a curved peripheral surface matching with the curved lower surface of the sealed section 112. The curved peripheral surface of the sealing disc 13 effectively prevents impurities and wastes in the waste water from staying around the sealing disc 13 to adversely affect a sealed condition at a joint 137 between the sealing disc 13 and the sealed section 112. The sealing disc 13 is provided with a through hole, which is aligned with the threaded hole 133 on the lower end surface of the torsion spring pull rod 129 when the switch unit 12 is mounted in the case 11. A screw is extended through the through hole on the sealing disc 13 into the threaded hole 133 to fixedly connect the sealing disc 13 to the torsion spring pull rod 129.

The connecting interface 2 is a hollow cylindrical member externally mounted around an upper part of the case 11 of the drain basket 1, so as to connect the drain basket 1 to the drain pipe or the existing bell-type floor drain. A first sealing ring 5 is mounted between the flange 111 of the case 11 and the connecting interface 2.

The sealing member 3 is an annular member externally mounted around the connecting interface 2. A contact surface between the connecting interface 2 and the sealing member 3 is sealed by an L-shaped second sealing ring 6. The second sealing ring 6 may be other suitable shape. The sealing member 3 is formed along an outer circumferential surface with a semi-circular recess 31, in which an O-ring 8 is mounted. With the sealing member 3, a good sealing effect is produced at the joint of the drain basket 1 and an inner wall surface of the drain pipe or the existing bell-type floor drain.

When the present invention is in use, waste water flown into the drain basket 1 applies a downward force on the sealing disc 13. At this point, the torsion spring pull rod 129 is caused to move downward and open the joint 137, allowing the waste water to flow into the drain pipe via the opened joint 137. When all the waste water has been drained, the torsion spring 136 brings the pull rod 129 upward, and the sealing disc 13 is caused to move upward and seal the joint 137 again, so that sewage, bad smell, hazardous gas, and insects are stopped from entering into a room via the floor drain due to a positive pressure state in the drain pipe.

It is noted the switch unit 12 in the present invention is mounted to one side of the drain basket 1. As compared with the existing floor drain having a sealing switch unit mounted to a center of the drain basket, a hindrance from the switch unit 12 of the present invention to the waste water flowing through the drain basket 1 is minimized, preventing an overflowed floor drain when there is a large amount of waste water. Moreover, the present invention eliminates the problem of hair and other impurities held to the switch unit. The switch unit 12 of the present invention also has simple structure and reduced components to enable convenient, stable, and safe use thereof.

What is claimed is:

1. A self-sealing floor drain, comprising a drain basket mounted in a drain pipe or an existing bell-type floor drain, and a sealing disc movably mounted at a water outlet of said drain basket; said drain basket being a hollow cylinder having a case; said self-sealing floor drain being characterized in that said case of said drain basket is provided on an inner wall surface with a switch unit, and said switch unit is internally provided with a torsion spring for opening and closing said sealing disc.

2. The self-sealing floor drain as claimed in claim 1, wherein said case of said drain basket is provided on an inner sidewall surface with a pair of slide grooves, and said switch unit is slidably mounted to said slide grooves.

3. The self-sealing floor drain as claimed in claim 2, wherein said switch unit is a hollow body having a trapezoid vertical section and a substantially oblong cross section, a top surface and a left end wall surface, both of which have a curved cross section, an open right end, two sidewalls, and a bottom surface; each of said two sidewalls being integrally provided along an end adjacent to said open right end with an outward protruded edge, said protruded edges having a cross section and size identical to that of said slide grooves on said case of said drain basket, so that said protruded edges may be inserted into said slide grooves; and said bottom surface of said switch unit being formed with a through hole.

4. The self-sealing floor drain as claimed in claim 3, wherein end surfaces of said sidewalls and said protruded edges of said switch unit in contact with said case have a curved cross section corresponding to that of the inner sidewall surface of said case.

5. The self-sealing floor drain as claimed in claim 4, wherein said bottom surface of said switch unit is integrally formed on an upper side thereof with a vertically extended hollow guide pipe, which is concentric with said through hole on said bottom surface and has an inner diameter the same as a diameter of said through hole; said hollow guide pipe having a cylindrical torsion spring pull rod provided therein; said torsion spring pull rod being provided on an outer wall surface with an axially extended groove, and said hollow guide pipe being provided on an inner wall surface with an axially extended rib corresponding to and received in said groove on said torsion spring pull rod.

6. The self-sealing floor drain as claimed in claim 5, wherein said torsion spring pull rod is provided near an upper end with a stopper to limit a distance by which said torsion spring pull rod can be moved downward in said hollow guide pipe; said torsion spring pull rod being provided at a lower end surface with an internally threaded hole, and at an upper end surface with a hole for a bar to insert therein, and said bar having a spring holding ring connected to a top thereof; said hollow guide pipe being also integrally formed on the outer wall surface with a spring seat, on a top center of which a dent is provided; and the torsion spring being mounted in said switch unit with two ends separately movably connected to said spring holding ring on said bar and said dent on said spring seat.

7. The self-sealing floor drain as claimed in any one of claims 1 to 6, wherein said drain basket includes a sealed section downward extended from a position slightly higher than the water outlet of said case to a slightly radially inward projected position, and said sealed section having curved upper and lower surfaces; said sealing disc having a curved peripheral surface matching with the curved lower surface of said sealed section; said sealing disc being provided with a through hole, which is aligned with said threaded hole on the lower end surface of said torsion spring pull rod, such that a screw may be extended through said through hole on said sealing disc into said threaded hole on said torsion spring pull rod to fixedly connect said sealing disc to said torsion spring pull rod.

8. The self-sealing floor drain as claimed in claim 7, wherein said case of said drain basket has a radially outward flange integrally formed around a top water inlet of said drain basket.

9. The self-sealing floor drain as claimed in claim 8, further comprising a connecting interface externally mounted around said case of said drain basket; said connecting interface being a hollow cylindrical member for connecting said drain basket to the drain pipe or the existing bell-type floor drain; and a first sealing ring being mounted between said flange of said case and said connecting interface.

10. The self-sealing floor drain as claimed in claim 9, further comprising an annular sealing member externally mounted around said connecting interface; and a contact surface between said connecting interface and said sealing member being sealed by an L-shaped second sealing ring; and said sealing member being formed along an outer circumferential surface with a semi-circular recess, in which an O-ring is mounted.
